(19) United States
(12) Patent Application Publication
(10) Pub. No.: US 2006/0073383 A1
(43) Pub. Date: Apr. 6, 2006

(54) Battery sheath and lithium polymer battery using the same

(76) Inventors: Won Chull Han, Cheonan-si (KR); Byoung Hyun Kang, Cheonan-si (KR); Joong Heon Kim, Cheonan-si (KR); Chang Sik Kim, Cheonan-si (KR); Seung Noh Lee, Cheonan-si (KR); Jae Keun Bang, Cheonan-si (KR)

Correspondence Address: CHRISTIE, PARKER & HALE, LLP, PO BOX 7068, PASADENA, CA, 91109-7068, US

(21) Appl. No.: 11/194,058

(22) Filed: Jul. 28, 2005

(30) Foreign Application Priority Data
Jul. 28, 2004 (KR) 2004-0059423

(51) Int. Cl. H01M 2/02; B32B 27/36; B32B 27/08; B32B 15/08

(52) U.S. Cl. 429/176; 428/483; 428/461

(57) ABSTRACT

A battery sheath having enough mechanical strength to stably protect a battery from external impact is provided. The battery sheath also has reduced thickness, thereby increasing battery capacity. In addition, the battery sheath suppresses swelling, thereby preventing battery deformation. The battery sheath includes a base layer having a first surface and a second surface opposite the first surface. A first adhesive is applied to the first surface of the base layer to a predetermined thickness. A CPP layer is applied to the first adhesive to a predetermined thickness. A PET layer is laminated at high temperature on the second surface of the base layer to a predetermined thickness.

### CROSS REFERENCE TO RELATED APPLICATION

This application claims priority to and the benefit of Korean Patent Application No. 20040059423, filed Jul. 28, 2004 in the Korean Intellectual Property Office, the entire content of which is incorporated herein by reference.

### FIELD OF THE INVENTION

The present invention relates to a battery sheath and a lithium polymer battery using the sheath. More particularly, the invention relates to a battery sheath having enough mechanical strength to stably protect the battery from external impact. The sheath also has a reduced thickness to increase battery capacity, and suppresses battery swelling, thereby preventing battery deformation.

### BACKGROUND OF THE INVENTION

As is generally known in the art, lithium polymer batteries comprise electrode assemblies, each of which generally comprises a separator positioned between positive and negative electrode collectors. The separator acts as an electrolyte, serving as a medium for ion conduction. The separator also serves as a medium for separation, a function similar to their role in lithium ion batteries. The separator comprises a gel-type polymer electrolyte, which is manufactured by impregnating a polymer with an electrolyte, thereby improving ion conductivity. In addition to improved ion conductivity, the gel-type polymer electrolyte imparts excellent bonding and mechanical properties to the electrodes, and makes the battery easy to manufacture. One representative electrolyte is a polyvinylidenefluoride (“PVDF”) based electrolyte, available from Bellcore Company, and is manufactured by mixing a copolymer of vinylidene fluoride (“VDF”) and hexafluoroethylene (“HFP”), a plasticizer, and an inorganic additive to form a film, impregnating the film with an electrolyte, and allowing the film to gel.

Unlike lithium ion batteries, lithium polymer batteries can have plate structures and do not require winding. Therefore, the electrode assembly in a lithium polymer battery can comprise a number of plates laminated together and can have a square shaped structure. In addition, the electrolyte in a lithium polymer battery is injected into a completely integrated cell, and rarely leaks. Also, the plate structure of the lithium polymer battery makes it unnecessary to apply pressure when making the square shaped structure. Therefore, a thin flexible pouch may be used as the battery sheath, instead of a hard square or cylindrical can.

When a flexible pouch is used as the battery sheath, the thickness of the battery is substantially less than that of a can, enabling more electrode assemblies to be formed within the same volume. This remarkably increases battery capacity. The flexible battery sheath allows the battery to take any desired shape and enable easy mounting of the battery on various electronic appliances.

However, although pouch-type battery sheaths have increased battery capacity and can be processed into various shapes, they have low mechanical strength and are very vulnerable to external impact. For example, a hole easily forms when the battery sheath is pierced by a sharp object (e.g., a needle or nail), and the sheath is easily torn if, for example, it is bitten by a pet. Furthermore, when a sharp object penetrates the sheath and contacts the internal electrode assembly, a short circuit occurs between the positive and negative electrode collectors, which may cause the battery to catch fire or explode.

In addition, lithium polymer batteries using such sheaths swell severely at high temperatures. Because the sheath surrounding the electrode assembly is flexible and has low mechanical strength, the thickness and shape of the battery easily deforms due to gas generated from the internal polymer electrolyte.

### SUMMARY OF THE INVENTION

In one embodiment, the present invention is directed to a battery sheath having enough mechanical strength to stably protect the battery from external impact In another embodiment, the present invention is directed to a lithium polymer battery using the sheath.

According to one embodiment of the present invention, the battery sheath has a reduced thickness and increased mechanical strength, thereby improving battery capacity. The battery sheath suppresses battery swelling, thereby preventing deformation of the thickness and shape of the battery.

One exemplary battery sheath comprises an approximately planar first surface and an approximately planar second surface opposite the first surface. The first and second surfaces may comprise a steel material. A first adhesive is applied to the first surface of the sheath and has a predetermined thickness. A cast polypropylene (“CPP”) layer is then applied to a predetermined thickness on the first adhesive. A polyethylene terephthalate (“PET”) layer is laminated at high temperature on the second surface to a predetermined thickness.

According to another embodiment of the present invention, a lithium polymer battery comprises an electrode assembly having at least one positive electrode collector, at least one negative electrode collector, and at least one separator between the positive and negative electrode collectors. The battery further comprises positive and negative electrode tabs coupled to the electrode assembly and extending a predetermined length from the positive and negative electrode collectors. A sheath comprises a first region having a cavity with a predetermined depth for containing the electrode assembly, and a second region adapted to cover the cavity of first region. In one embodiment, the sheath comprises a steel material.

The sheath according to one embodiment of the present invention comprises a steel material having high mechanical strength, thereby enabling the sheath to stably protect the battery from external impact. The high mechanical strength of the sheath reduces battery thickness and increases the volume of the electrode assembly. This increases battery capacity. In addition, the high mechanical strength of the sheath suppresses swelling and prevents the deformation of battery thickness and battery shape.

### BRIEF DESCRIPTION OF THE DRAWINGS

The above and other features and advantages of the present invention will become more apparent with reference to the following detailed description when considered in conjunction with the accompanying drawings, in which:

FIG. 1 is a perspective view of a battery sheath, before formation of a cavity, according to one embodiment of the present invention;

FIG. 2a is a cross-sectional view of the battery sheath of FIG. 1;

FIG. 2b is a magnified view of region 2b of the battery sheath of FIG. 2a;

FIG. 3a is a cross-sectional view of a battery sheath according to another embodiment of the present invention;

FIG. 3b is a magnified view of region 3b of FIG. 3a;

FIG. 4 is a perspective view of a battery sheath having a cavity according to one embodiment of the present invention;

FIG. 5 is a perspective view of a lithium polymer battery according to one embodiment of the present invention; and

FIG. 6 is a cross-sectional view of the battery of FIG. 5.

### DETAILED DESCRIPTION

Exemplary embodiments of the present invention will now be described with reference to the accompanying drawings. Throughout the following description and in the drawings, like reference numerals are used to designate like components in order to avoid repetitive descriptions of same or similar components.

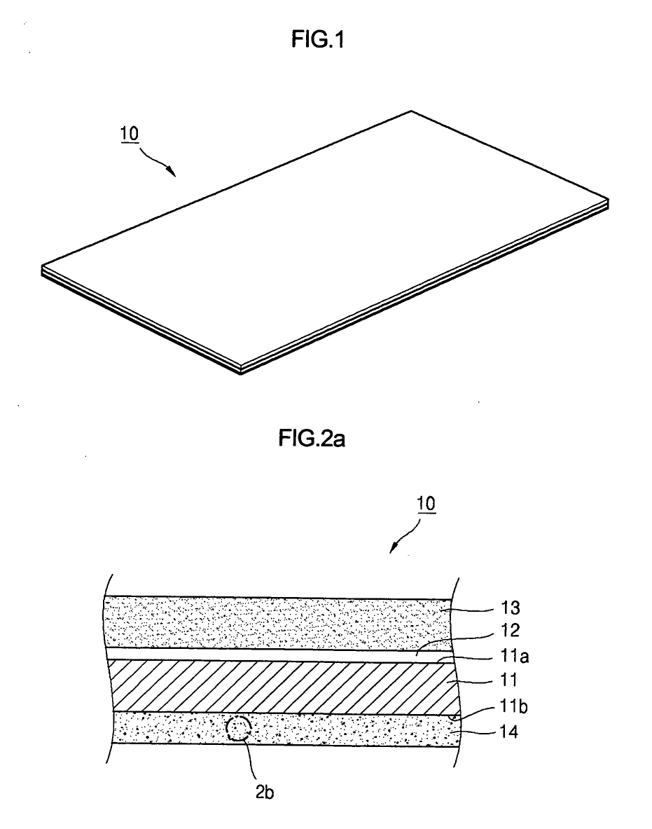

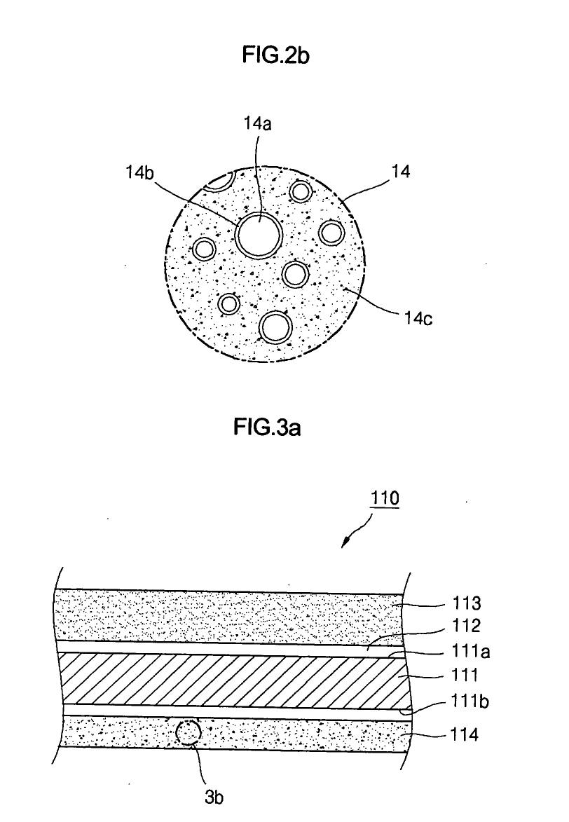

FIG. 1 is a perspective view of a battery sheath 10 according to one embodiment of the present invention. The sheath is shown before formation of a cavity. FIG. 2a is a cross-sectional view of the battery sheath of FIG. 1. FIG. 2b is a magnified view of region 2a of FIG. 2a. As shown, a battery sheath 10 according to one embodiment of the present invention generally comprises a base layer 11, a first adhesive 12, a cast polypropylene (“CPP”) layer 13, and a polyethylene terephthalate (“PET”) layer 14. In one embodiment, the base layer 11 comprises a steel material.

The base layer 11 comprises a first surface 11a and a second surface 11b opposite the first surface 11a. Each of the first and second surfaces 11a and 11b, respectively, may comprise a generally planar surface. The combined thickness of the first and second surfaces 11a and 11b, respectively, ranges from about 5 to about 100 μm, which is less than the thickness of prior art sheaths by several microns to tens of microns. The base layer 11 has increased mechanical strength and reduced thickness. Therefore, more electrode assemblies (not shown) can be contained within the same volume. The base layer 11 may comprise a material selected from the group consisting of alloys of iron (Fe), carbon (C), chromium (Cr), and manganese (Mn) and alloys of iron (Fe), carbon (C), chromium (Cr), and nickel (Ni). For example, the base layer 11 may comprise an alloy including from about 84 to about 88.2% iron, about 0.5% or less carbon, from about 11 to about 15% chromium, and from about 0.3 to about 0.5% manganese. Alternatively, the base layer 11 may comprise an alloy including from about 63.7 to about 75.9% iron, from about 0.1 to about 0.3% carbon, from about 12 to about 18% chromium, and from about 7 to about 12% nickel. In another alternative, the base layer 11 may comprise a material selected from the group consisting of Korean Industrial Standard (KS) STS301, KS STS304, KS STS305, KS STS316L, KS STS321, Japanese Industrial Standard (JIS) SUS301, JIS SUS304, JIS SUS305, JIS SUS316L and JIS SUS321. However, it is understood that any suitable material may be used for the base layer 11.

In one embodiment, the base layer 11 comprises an alloy of iron (Fe) having high mechanical strength, chromium (Cr) having strong resistance to corrosion, and/or nickel (Ni). Such a base layer 11 increases the mechanical strength of the battery sheath 10 and increases the resistance to the electrolyte. The base layer 11 prevents moisture from penetrating the battery. In one embodiment, the base layer 11 has an elongation ratio of about 20 to about 60%, enabling easy formation of a cavity (not shown). This elongation ratio prevents the base layer 11 from being damaged during formation of the cavity. The cavity is formed to a predetermined depth by a die, and contains the electrode assembly. For example, the base layer 11 may be annealed in an inactive gas atmosphere at a temperature of hundreds of degrees Celsius to maintain the elongation ratio at about 20 to about 60%. Furthermore, the characteristics of the base layer 11 enable suppression of swelling which may occur at higher temperatures after battery assembly. Therefore, deformation of the thickness and shape of the battery is sufficiently prevented.

The first adhesive 12 is applied to the first surface 11a of the base layer 11 to a thickness of several microns. The first adhesive 12 may comprise a polypropylene-based adhesive. However, it is understood that any suitable adhesive may be used.

A CPP layer 13 is applied to the first adhesive 12 to a thickness of about 30 to about 40 μm. The CPP layer 13 may have a thickness slightly greater than that of the base layer 11, because the CPP layer 13 directly contacts and is thermally bonded to the electrode assembly.

The PET layer 14 is applied to the second surface 11b of the base layer 11 to a predetermined thickness. Particularly, the PET layer 14 is applied to the second surface 11b of the base layer 11 by lamination at high temperature. The PET layer 14 is applied to the second surface 11b to a thickness of about 5 to about 10 μm. The PET layer 14 may comprise an alloy film. More particularly, the PET layer 14 may further comprise rubber particles 14a for enhancing resistance to impact, a solubilizer 14b surrounding the rubber particles 14a for enhancing adherence, and an adhesive 14c. The rubber particles 14a increase the elongation ratio and the resistance to impact. The solubilizer 14b improves adherence to the base layer 11, and particularly to the second surface 11b of the base layer 11. The adhesive 14c, previously applied to the PET layer 14 enables direct lamination of the PET layer 14 at high temperature without applying any special adhesive to the base layer 11. This further simplifies the manufacturing process of the battery sheath 10.

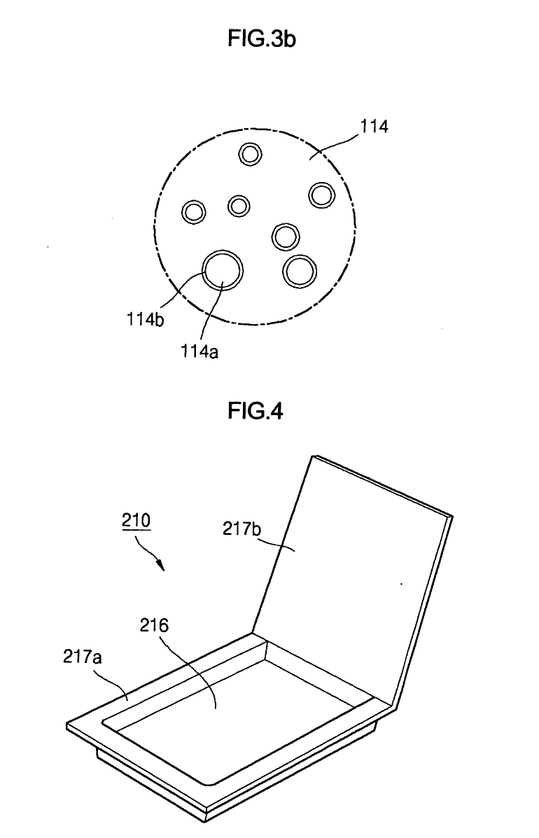

FIG. 3a is a cross-sectional view of a battery sheath 110 according to another embodiment of the present invention. FIG. 3b is a magnified view of region 3b of FIG. 3a. As shown, the battery sheath 110 may additionally comprise a second adhesive 125 applied to the second surface 111b of the base layer 111. The second adhesive 125 may comprise a polypropylene-based adhesive, but it is understood that any suitable adhesive may be used.

In this embodiment, the PET layer 114 does not include an adhesive, because the second adhesive 125 is previously formed. Namely, the PET layer 114 comprises rubber particles 114a for enhancing resistance to impact, and a solubilizer 114b surrounding the rubber for enhancing adherence. The PET layer 114 may be formed by laminating it on the second adhesive 125 at high temperature. The PET layer 114 and the remaining components of the sheath 110 have the same configuration as the sheath 10 of the embodiment described above with reference to FIGS. 1, 2a and 2b.

FIG. 4 is a perspective view of a battery sheath 210 according to another embodiment of the present invention. The sheath 210 comprises a cavity 216 for containing an electrode assembly. As shown, the battery sheath 210 comprises a first region 217a and a second region 217b which are folded together such that their edges are thermally bonded. The first region 217a may comprise a cavity 216 having a predetermined width and depth for containing an electrode assembly (not shown). The electrode assembly comprises at least one positive electrode collector, at least one negative electrode collector and at least one separator between the positive and negative electrode collectors. The second region 217b may also comprise a cavity (not shown). The base layer, which is the main material of the sheath 210, has an elongation ratio of about 20 to about 60% for preventing the sheath 210 from being damaged during formation of the cavity 216.

The cavity 216 is formed such that the CPP layer directly contacts a mold. Therefore, the thickness of the CPP layer is greater than the thickness of the base layer, and the thickness of the base layer is greater than the thickness of the PET layer. The CPP layer is the thickest because the portion of CPP layer on the outer peripheral edges of the first and second regions 217a and 217b, respectively, are thermally bonded to each other.

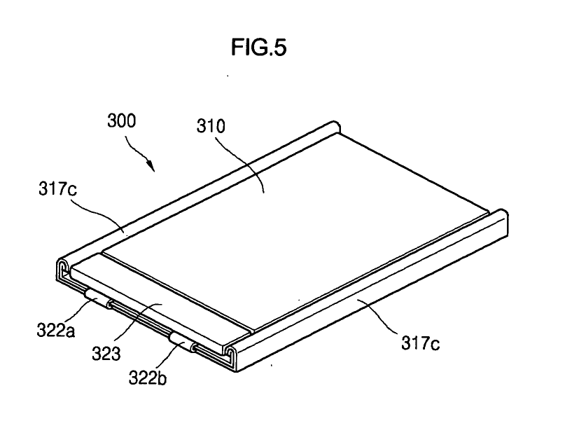

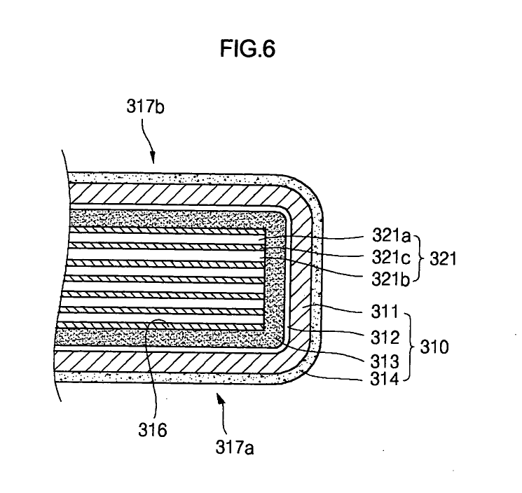

FIG. 5 is a perspective view of a lithium polymer battery 300 according to one embodiment of the present invention. FIG. 6 is a cross-sectional view of the battery of FIG. 5. As shown, the lithium polymer battery 300 according to this embodiment of the present invention comprises an electrode assembly 321, a sheath 310, and a protective circuit module 323.

The electrode assembly 321 is formed by laminating at least one positive electrode collector 321a, at least one negative electrode collector 321b, and at least one separator 321c between the positive and negative electrode collectors 321a and 321b, respectively. The positive electrode collector 321a comprises lithium cobalt oxide (LiCoLO₂) on aluminum (Al) foil. The negative electrode collector 321b comprises graphite on copper (Cu) foil. The separator 321c comprises a gel-type polymer electrolyte. At least one positive electrode tab 322a, comprising aluminum, is bonded to the aluminum foil of the positive electrode collector 321a, and at least one negative electrode tab 322b, comprising nickel is bonded to the copper foil of the negative electrode collector 321b. The positive and negative electrode tabs 322a and 322b extend a predetermined length from the exterior of the sheath 310.

The sheath 310 comprises a first region 317a comprising a cavity 316 having a predetermined depth for containing the electrode assembly 321, and a second region 317b for covering the cavity 316 of the first region 317a.

The sheath 310 comprises a base layer 311, a first adhesive 312 applied to a first surface of the base layer 311, a CPP layer 313 applied to the first adhesive 312, and a PET layer 314 laminated at high temperature on a second surface of the base layer 311. A second adhesive (not shown) may optionally be applied between the base layer 311 and the PET layer 314. The CPP layer 313 surrounds the electrode assembly 321, and the PET layer 314 is positioned on the outermost surface of the sheath 310. The CPP layers 313 on the outer peripheral edges 317c of the first and second regions 317a and 317b, respectively, of the sheath 310, are thermally bonded to each other and can be folded such that the volume of the sheath 310 is minimized. The remaining features of the sheath 310 are similar to those described above with reference to FIGS. 1 through 4a.

The protective circuit module 323 is attached to a side of the sheath 310 to protect the battery 300 from voltage or current generated during overcharging or over-discharging. The protective circuit module 323 is electrically connected to the positive and negative electrode tabs 322a and 322b, respectively.

As described above, the battery sheath comprises a base layer having high mechanical strength such that the sheath stably protects the battery from external impact. High mechanical strength of the sheath enables reduced battery thickness and increased volume of the electrode assembly. This increases battery capacity. High mechanical strength of the sheath also suppresses swelling and prevents deformation of the thickness and shape of the battery.

Exemplary embodiments of the present invention have been described for illustrative purposes. However, those skilled in the art will appreciate that various modifications, additions and substitutions may be made to the described embodiments without departing from the scope and spirit of the invention as disclosed in the accompanying claims.

What is claimed is:

1. A battery sheath comprising:
a base layer having a first surface and a second surface;
a first adhesive on the first surface of the base layer;
a cast polypropylene (“CPP”) layer on the first adhesive; and
a polyethylene terephthalate (“PET”) layer on the second surface of the base layer.

2. A battery sheath as claimed in claim 1, wherein the base layer comprises a steel material.

3. A battery sheath as claimed in claim 1, further comprising a second adhesive between the second surface of the base layer and the PET layer.

4. A battery sheath as claimed in claim 3, wherein the PET layer comprises a plurality of rubber particles and a solubilizer surrounding the rubber particles.

5. A battery sheath as claimed in claim 1, wherein the base layer has a thickness ranging from about 5 to about 100 μm.

6. A battery sheath as claimed in claim 1, wherein the base layer comprises a material selected from the group consisting of alloys of iron, carbon, chromium, and manganese, and alloys of iron, carbon, chromium, and nickel.

7. A battery sheath as claimed in claim 1, wherein the base layer has an elongation ratio ranging from about 20 to about 60%.

8. A battery sheath as claimed in claim 1, wherein the PET layer comprises an alloy film.

9. A battery sheath as claimed in claim 1, wherein the PET layer further comprises a plurality of rubber particles, a solubilizer surrounding the rubber particles, and an adhesive.

10. A battery sheath as claimed in claim 1, wherein the PET layer has a thickness ranging from about 5 to about 10 μm.

11. A battery sheath as claimed in claim 1, further comprising:
a first region having a cavity sized to contain an electrode assembly, the electrode assembly including at least one positive electrode collector, at least one negative electrode collector, and at least one separator between the positive and negative electrode collector; and
a second region covering the first region.

12. A battery sheath as claimed in claim 10, wherein the CPP layer comprises a first region on an outer peripheral edge of the cavity of the first region of the base layer, the CPP layer further comprising a second region on an outer peripheral edge of the second region of the base layer, the first and second regions of the CPP layer being thermally bonded to each other.

13. A battery sheath as claimed in claim 1, wherein the base layer comprises an alloy comprising:
from about 84 to about 88.2% iron;
about 0.5% or less carbon;
from about 11 to about 15% chromium; and
from about 0.3 to about 0.5% manganese.

14. A battery sheath as claimed in claim 1, wherein the base layer comprises an alloy comprising:
from about 63.7 to about 75.9% iron;
from about 0.1 to about 0.3% carbon;
from about 12 to about 18% chromium; and
from about 7 to about 12% nickel.

15. A battery sheath as claimed in claim 1, wherein the base layer comprises a material selected from the group consisting of Korean Industrial Standard (KS) STS301, KS STS304, KS STS305, KS STS316L, KS STS321, Japanese Industrial Standard (JIS) SUS301, JIS SUS304, JIS SUS305, JIS SUS316L and JIS SUS321.

16. A battery sheath as claimed in claim 1, wherein the CPP layer has a thickness ranging from about 30 to about 40 μm.

17. A lithium polymer battery comprising:
an electrode assembly having at least one positive electrode collector, at least one negative electrode collector, at least one separator between the positive and negative electrode collector, at least one positive electrode tab, and at least one negative electrode tab, the positive and negative electrode tabs being coupled to the electrode assembly and extending a predetermined length from the positive and negative electrode collectors; and
a sheath including a base layer, the base layer comprising:
a first region comprising a cavity, the cavity having a depth to contain the electrode assembly, and
a second region covering the cavity of the first region.

18. A lithium polymer battery as claimed in claim 17, wherein the sheath comprises:
a base layer having a first surface and a second surface;
a first adhesive on the first surface of the base layer;
a cast polypropylene (“CPP”) layer on the first adhesive; and
a polyethylene terephthalate (“PET”) layer on the second surface of the base layer.

19. A lithium polymer battery as claimed in claim 18, wherein the base layer comprises a steel material.

20. A lithium polymer battery as claimed in claim 18, wherein the sheath further comprises a second adhesive between the second surface of the base layer and the PET layer.

21. A lithium polymer battery as claimed in claim 20, wherein the PET layer comprises a plurality of rubber particles and a solubilizer surrounding the rubber particles.

22. A lithium polymer battery as claimed in claim 18, wherein the base layer has a thickness ranging from about 5 to about 100 μm.

23. A lithium polymer battery as claimed in claim 18, wherein the base layer comprises a material selected from the group consisting of alloys of iron, carbon, chromium, and manganese and alloys of iron, carbon, chromium, and nickel.

24. A lithium polymer battery as claimed in claim 17, wherein the base layer has an elongation ratio ranging from about 20 to about 60%.

25. A lithium polymer battery as claimed in claim 18, wherein the PET layer comprises an alloy film.

26. A lithium polymer battery as claimed in claim 18, wherein the PET layer further comprises a plurality of rubber particles, a solubilizer surrounding the rubber particles, and an adhesive.

27. A lithium polymer battery as claimed in claim 18, wherein the PET layer has a thickness ranging from about 5 to about 10 μm.

28. A lithium polymer battery as claimed in claim 17, further comprising a protective circuit module connected to the positive and negative electrode tabs.

29. A lithium polymer battery as claimed in claim 18, wherein the CPP layer comprises a first region on an outer peripheral edge of the cavity of the first region of the base layer, the CPP layer further comprising a second region on an outer peripheral edge of the second region of the base layer, the first and second regions of the CPP layer being thermally bonded to each other.

30. A lithium polymer battery as claimed in claim 18, wherein the base layer comprises an alloy including:
from about 84 to about 88.2% iron;
about 0.5% or less carbon;
from about 11 to about 15% chromium; and
from about 0.3 to about 0.5% manganese.

31. A lithium polymer battery as claimed in claim 18, wherein the base layer comprises an alloy comprising:
from about 63.7 to about 75.9% iron;
from about 0.1 to about 0.3% carbon;
from about 12 to about 18% chromium; and
from about 7 to about 12% nickel.

32. A lithium polymer battery as claimed in claim 18, wherein the base layer comprises a material selected from the group consisting of Korean Industrial Standard (KS) STS301, KS STS304, KS STS305, KS STS316L, KS STS 321, Japanese Industrial Standard (JIS) SUS301, JIS SUS304, JIS SUS305, JIS SUS316L and JIS SUS321.

33. A lithium polymer battery as claimed in claim 18, wherein the CPP layer has a thickness ranging from about 30 to about 40 μm.
